(19) United States
(12) Patent Application Publication
(10) Pub. No.: US 2014/0292462 A1
(43) Pub. Date: Oct. 2, 2014

(54) POWER INDUCTOR AND METHOD FOR FABRICATING THE SAME

(71) Applicant: INPAQ TECHNOLOGY CO., LTD., Miaoli (TW)

(72) Inventor: Wei-Chih LEE, New Taipei City (TW)

(73) Assignee: INPAQ TECHNOLOGY CO., LTD., Miaoli (TW)

(21) Appl. No.: 13/852,231

(22) Filed: Mar. 28, 2013

(51) Int. Cl. H01F 27/29; H01F 41/04

(52) U.S. Cl. CPC H01F 27/29; H01F 41/04
USPC 336/192; 29/602.1

(57) ABSTRACT

A power inductor and its fabrication method are disclosed. The power inductor comprises a lower substrate, a coil provided on the lower substrate, and an intermediate layer which encloses the coil, wherein the lower substrate can be a soft magnetic entrainer or a non-magnetic entrainer. The coil is made of a conductive wire coated with insulated layer, and the intermediate layer is a material consisting of magnetic properties. The steps of fabrication consists of: forming a base conductive pole on the upper surface of the lower substrate, putting the coil connected to said base conductive pole, and enveloping said coil with magnetic material.

### BACKGROUND OF THE INVENTION

1. Field of the Invention

The present invention relates to a power inductor and method for fabricating the same, and more particularly to a power inductor which has much more reliability when it is connected to outer electrode, and has enhanced function of heat radiation, as well as the method for fabricating the power inductor.

2. Description of Prior Art

Referring to FIG. 1A through 1D, which are the drawings showing a conventional power inductor disclosed in an invention of U.S. Pat. No. 6,204,744B1. In the drawings, a coil 10 which is attached to a circuit board 12, has an enclosure 14. From the enclosure 14 there extend a first conductor 16 and a second conductor 18 each respectively welded to welding pads 20 and 22. The coil 10 is a helical winding body 24 with multiple turns 30 of an erected rectangular cross sectional flat wire. The coil 10 includes an inner side end 26 and an outer side end 28, and a lead frame 32 is attached to the winding body 24 with its two terminals 34 and 38 each respectively welded to the inner side end 26 and the outer side end 28 of the winding body 24. Afterwards the winding body 24 with both welded conductors 16, 18 is set in a mold, and then the mold filled with preferably, a colloidal magnetic powder. After the magnetic powder is dried and hardened, the lead frame 32 is severed and taken away. The finished product of the inductor of the invention is obtained.

However, the inductor fabricated according to U.S. Pat. No. 6,204,744B1 has the following flaws, namely:
1. In fabricating the power inductor, the coil is welded to a conductive wire, and then placed into a casting mold, after that, inside the casting mold is filled with magnetic powder and adhesive gel and then pressed by pressure machine. If the pressure is not enough, the coil and magnetic powder won't adhesively compact together. If the pressure is over used, then the interface between two different materials shall be broken, a problem of reliability to power inductor after long timed application then is occurred.
2. The coil used in conventional power inductor is enveloped with magnetic material and adhesive gel, thus when it is applied in the circumstance of high current, the temperature of it shall quickly go up, even burn out the power inductor.
3. In a traditional power inductor, the way of connection of the inductor to the outer conductor terminals belongs to a point-to-point contact. In this manner, when the power inductor is used under the circumference in which the temperature is violently changed or loaded for a long time, the coil body and the outer electrical terminals may be easily disconnected causing an accidental open circuit, or moreover, a burn down of the load side electronic product.
4. One by one fabrication process as that conducted at present leads to a great loss of manpower and time with a result of low production efficiency. In the fabrication, the two ends of the coil are at first welded to the corresponding two supporting legs of the lead frame, and the connecting conductors are cut after completing the fabrication to separate the lead frame. This also causes the loss of material and increase of the fabrication cost.

For these defects noticeable on the prior art, an improvement is seriously required. The inventor has dedicated great efforts for years to studying and improving these defects and finally come out with the present invention.

### SUMMARY OF THE INVENTION

Accordingly, it is an object of the present invention to provide a power inductor and method for fabricating the same in which the lower substrate is selected from a high heat conductive material having a thickness of 1 μm˜500 μm with heat conduction coefficient greater than 0.5 w/mk, such that the fabricated power inductor has the function of high heat conduction and radiation.

To achieve the above object, the present invention provides a power inductor in which a conductive electrode is formed on a lower substrate, next, forming conductive coils among the electrodes, and then enclosing the conductive coil with a colloidal magnetic material, and then forming end electrode to obtain a surface mounting power inductor.

According to the power inductor and method for fabricating the same of present invention, the mass production can be performed at one time efficiently, so as to curtail the production cost, and the finished product can fulfill the aims of light, thin, short and compact to meet the requirements of the present day electronic devices.

In the present invention, the coil leads of a inductor unit do not have to be welded to the supporting legs of the lead frame to form the terminals of the inductor unit. In this way, the process of preparing the lead frame and welding the coil leads can be omitted so that the cost of fabrication can be greatly reduced.

In the present invention, omission of preparing a lead frame results in saving the cost of the lead frame, and the cost of performing process of cutting off the lead frame.

The power inductor fabricated as such not only has the advantageous features qualified for the modern electronic device as described above, but also has a significant feature that its coil is closely combined with the outer electric terminals within the main body of the inductor without the fear of accidental separation of coil from its lead wires resulting in breakdown of the whole electronic installation.

### BRIEF DESCRIPTION OF THE DRAWINGS

The following drawings, which are included to provide further understanding of the invention and incorporated in and constitute part of this specification, illustrate embodiments of the invention and together with the description serve to explain the principles of the invention; wherein

FIG. 1A˜FIG. 1D show an embodiment of U.S. Pat. No. 6,204,744B1;

FIG. 2 is a perspective view of the power inductor according to the present invention;

FIG. 3 is a perspective view of the power inductor according to the present invention in which end electrodes are formed at both sides of the main body;

FIG. 4-1˜FIG. 4-8 are illustrative views showing the process of fabrication method for manufacturing a single power inductor according to a preferred embodiment of present invention; and

FIG. 5-1˜FIG. 5-9 are illustrative views showing the process of fabrication method for forming a plurality of power inductor according to an embodiment of present invention.

FIG. 6 is an another embodiment of present invention.

### DETAILED DESCRIPTION OF THE PREFERRED EMBODIMENTS

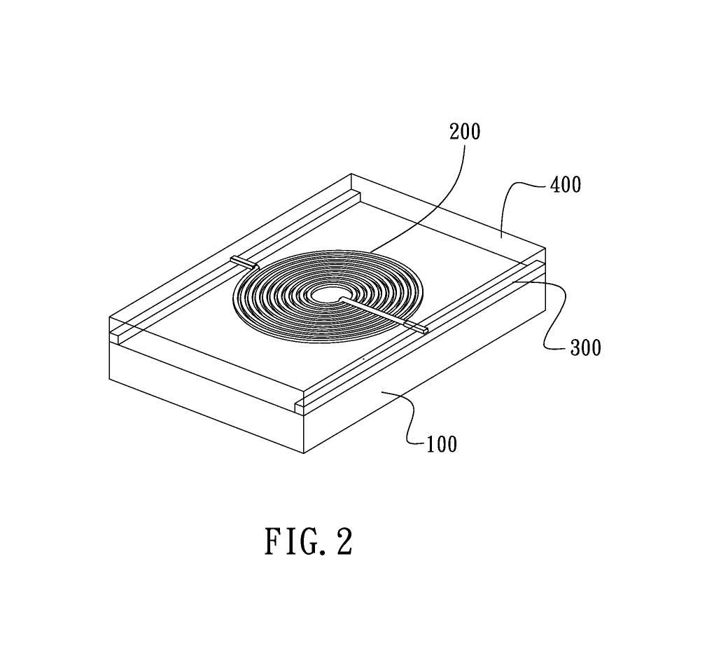

As shown in FIG. 2, the power inductor of present invention comprises a lower substrate 100, a basic conductive electrode pattern 300 formed on the lower substrate 100, a coil 200 loaded on the lower substrate 100, and an enclosing layer 400 enclosing the coil 200, wherein the lower substrate 100 is selected from a high heat conductive material having a thickness of 1 μm˜500 μm with heat conductive coefficient greater than 0.5 w/mk. It may be a soft magnetic substrate, or a glass fiber substrate, or a plate of conductive material;

wherein, if the lower substrate is an electric-conductive substrate having high heat conductive coefficient, then the two end points of electric-conductive substrate can be insulated by cutting or etching the substrate.

The coil 200 is formed of conducting wire wrapped with an insulating layer. The basic conductive electrode pattern 300 is formed of Ag, Sn, Cu, Al, Ni, or other conducting materials. The basic conductive electrode pattern 300 and the coil 200 are electrically connected with each other. The enclosing layer 400 is made of colloidal substance containing the magnetic properties.

The power inductor of present invention can be manufactured as a single granular element or a plurality of granular elements, wherein the process for manufacturing single granular element is illustrated in Embodiment 1 and the process for manufacturing a plurality of granular elements is illustrated in Embodiment 2.

### Embodiment 1

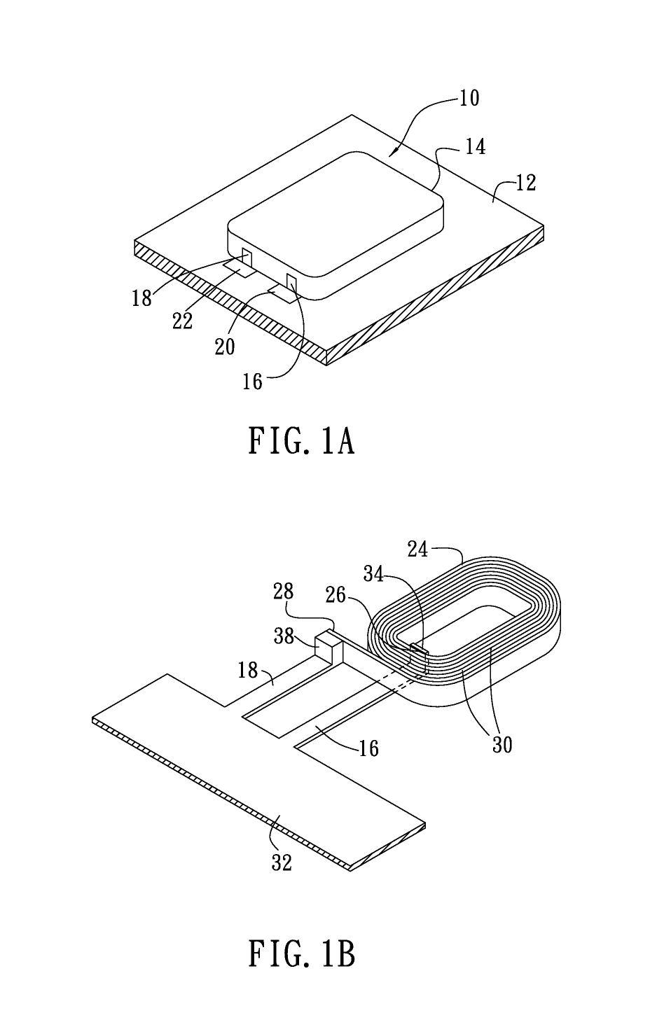

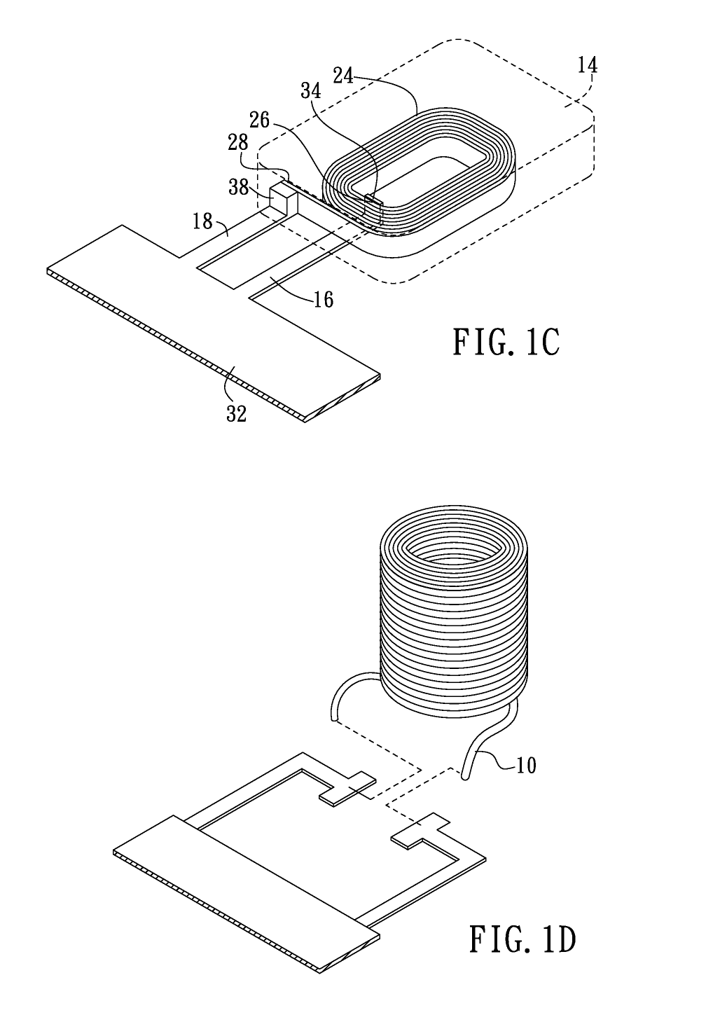

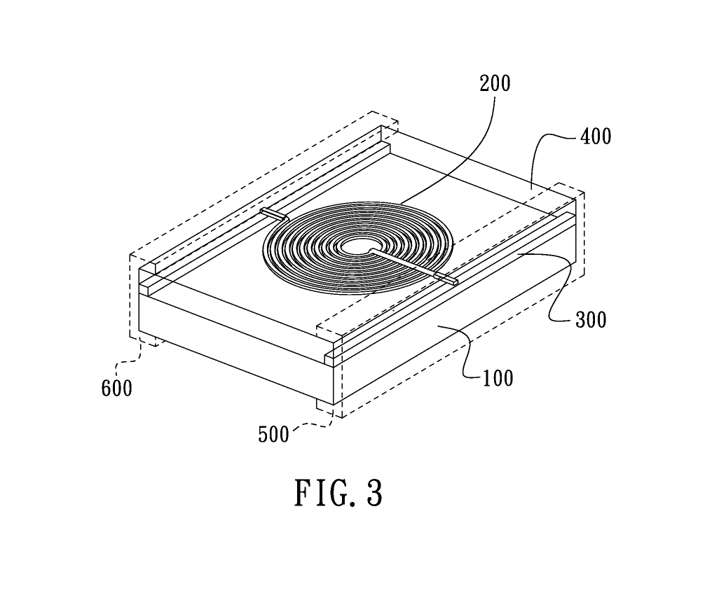

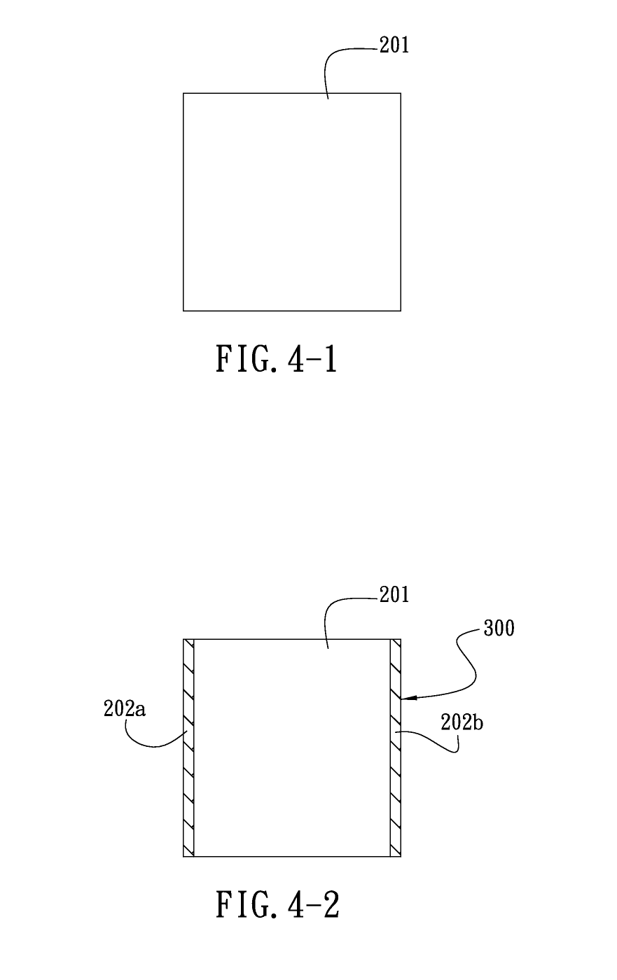

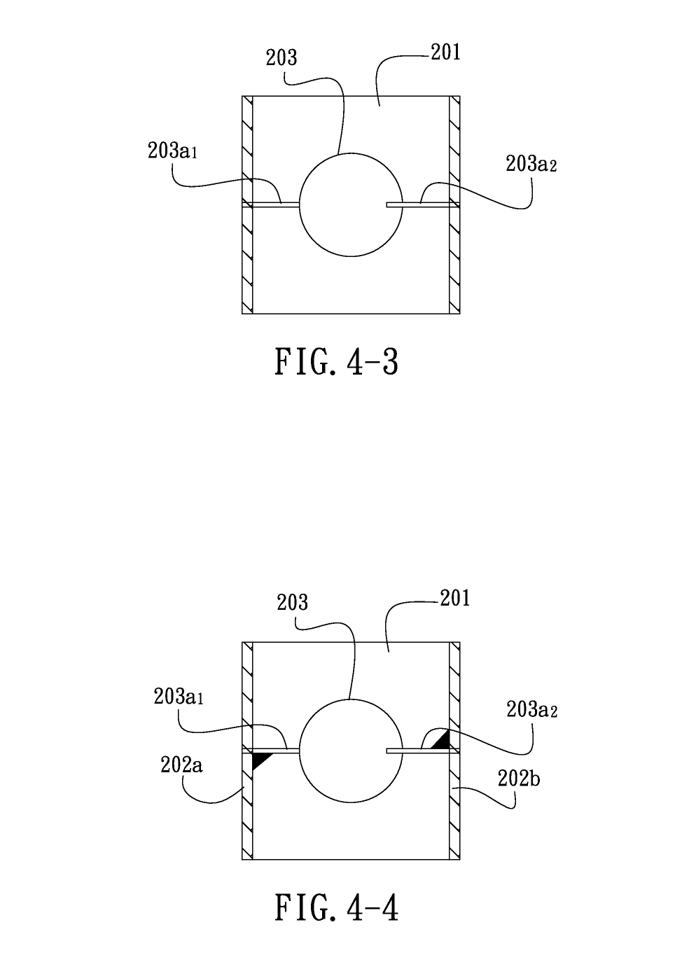

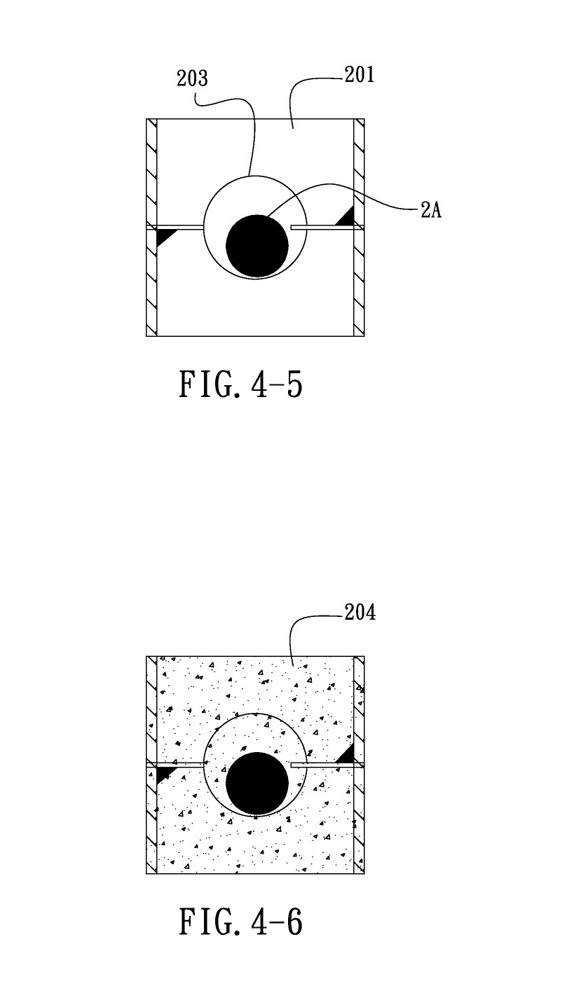

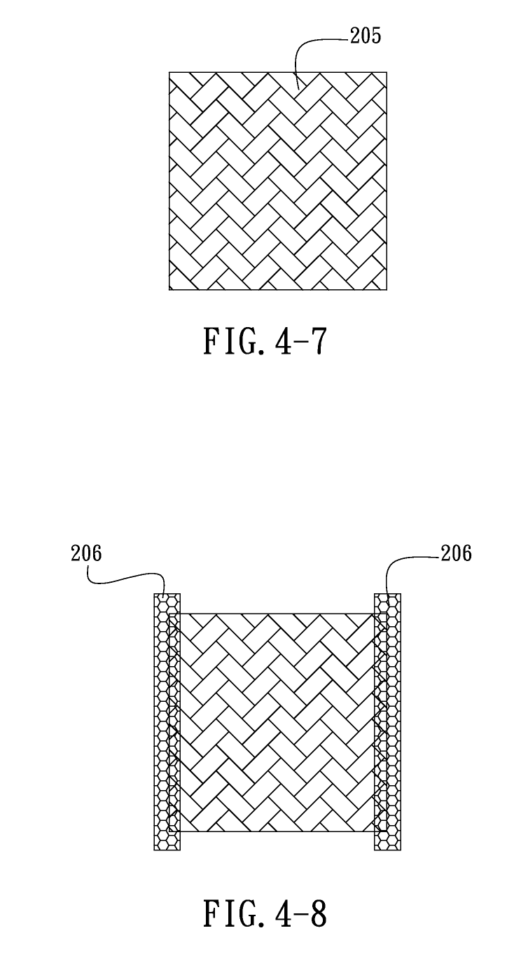

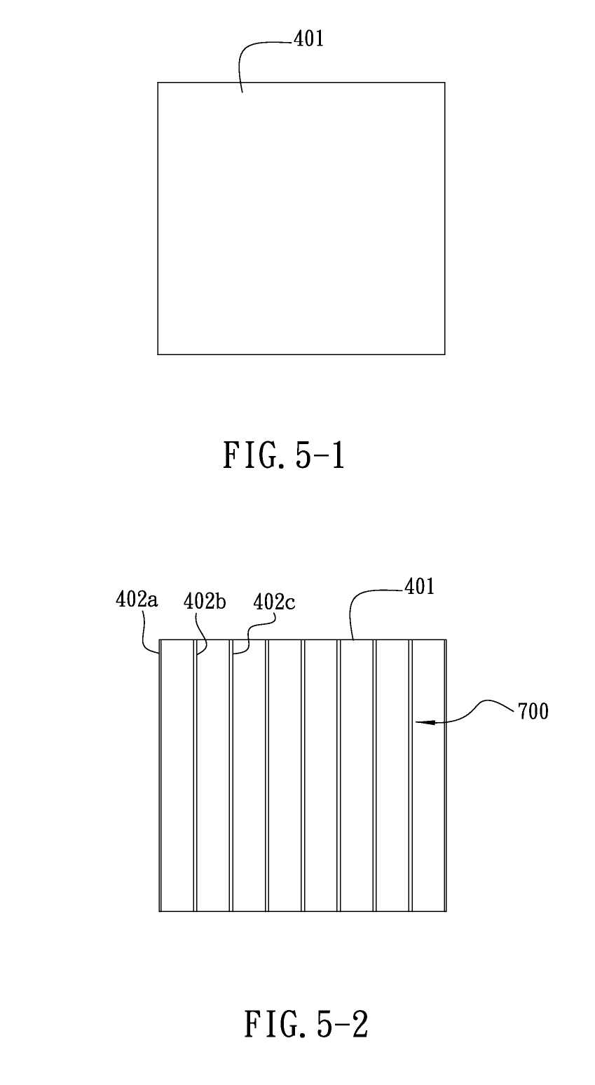

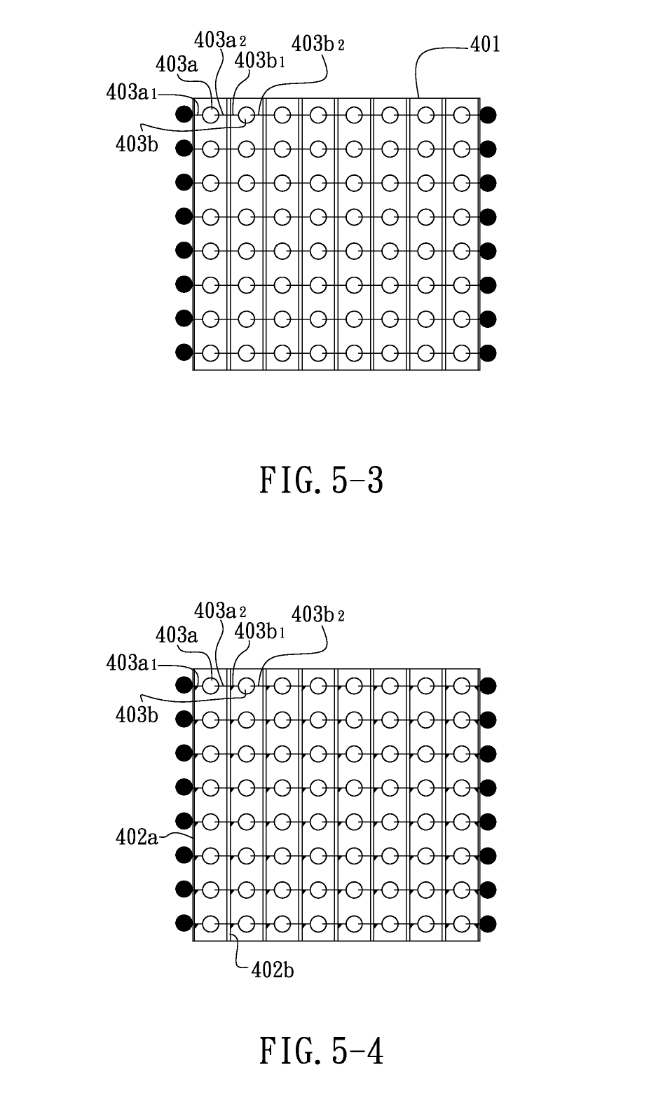

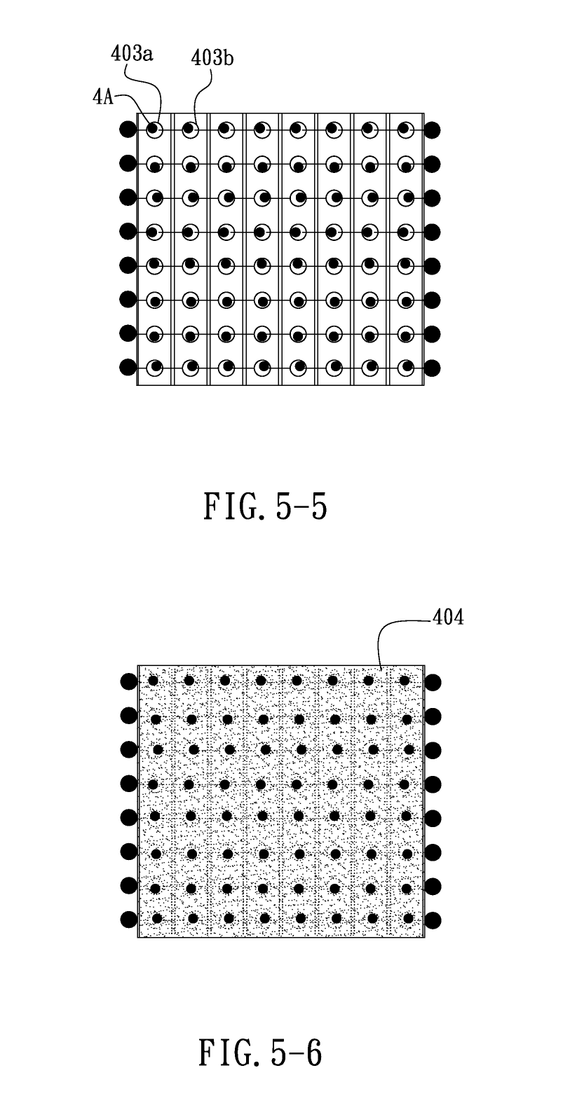

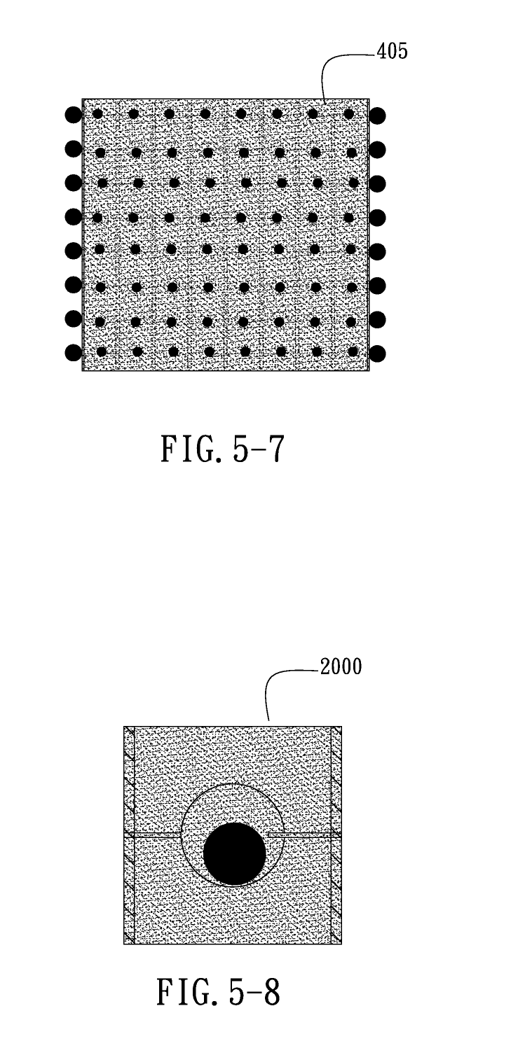

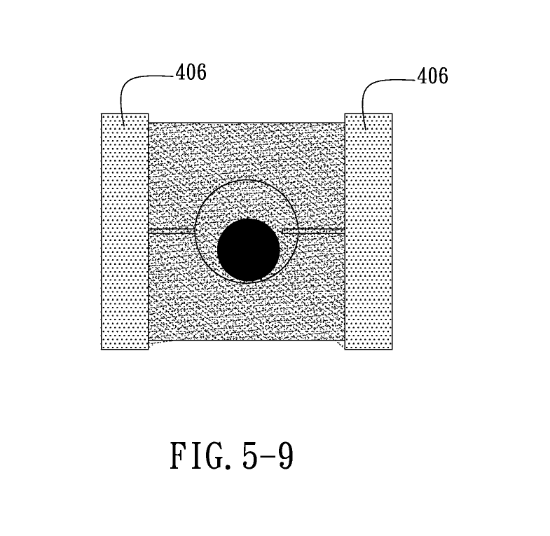

The method for manufacturing a single granular element of power inductor of present invention includes the steps of:
1. Selecting and obtaining a lower substrate 201 which is a soft magnetic plate or a glass fiber substrate or a plate of conductive material having a thickness of 1 μm˜500 μm with heat conductive coefficient greater than 0.5 w/mk (please refer to FIG. 4-1).
2. Forming a basic conductive electrode pattern 300 having a plurality of separated conductive electrodes 202a, 202b made of Cu, Ag, Al, Sn, Ni, or other conductive materials, or their alloys stacked one another on the lower substrate 201. The thickness of basic conductive electrode pattern 300 is 0.1 μm˜1 mm (please refer to FIG. 4-2).
3. Forming a coil 203 on the upper surface of the lower substrate 201. The two ends of coil 203 are lead wires 203a1, 203a2, the material of coil is copper or another conductive material, wherein, the copper wire can be coated by an insulated layer such as lacquer (please refer to FIG. 4-3, it has to be noticed that the order of step 2 and step 3 can be changed).
4. Making electrical connection between the lead wires 203a1, 203a2 of coil 203 and the corresponding conductive electrodes 202a, 202b (please refer to FIG. 4-4). This process is performed by welding or heat pressing.
5. Putting a pole 2A (as shown in FIG. 4-5) into said coil 203, said pole 2A is a bar of magnetic or non-magnetic material, such as iron or related alloys and oxides; said pole 2A is used for adjusting electric properties of power inductor.
6. Coating the surface of coil 203 with a magnetic material colloid 204, this magnetic material colloid 204 may be a ferrite or iron and its alloy powder (please see FIG. 4-6).
7. Covering an upper substrate 205 on the upper surface of the magnetic material colloid 204 serving as a fixing layer (please refer to FIG. 4-7). The upper and the lower substrates 205, 201 may be formed of the same material. After that baking the workpiece at 200° C., so as to harden the magnetic material colloid 204 and stick it to the upper substrate 205 to form a single granular element.
8. After the single granular element is obtained, forming end electrodes 206 on its side surfaces, then the product of power inductor becomes a surface mounting device (as shown in FIG. 4-8).

### Embodiment 2

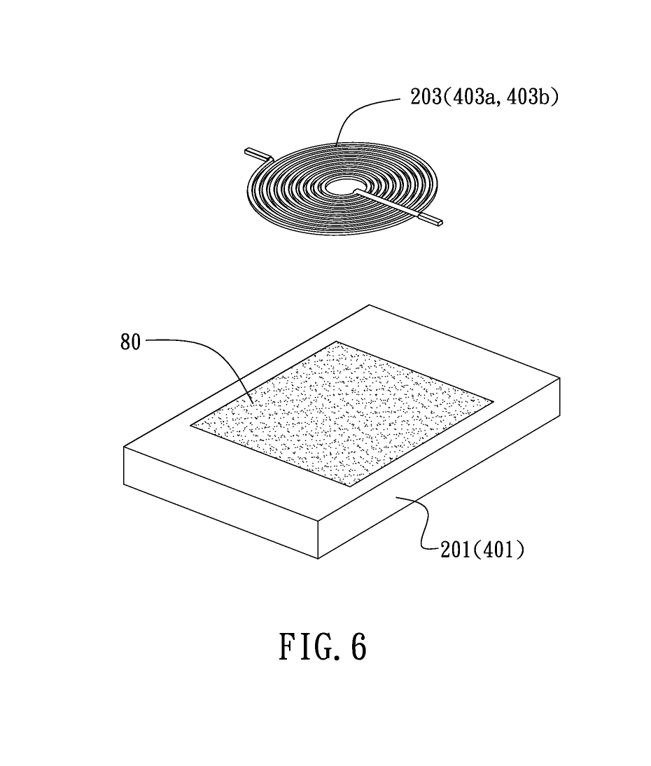

The method for manufacturing a plurality of granular elements of power inductor of present invention includes the steps of:
1. Selecting and obtaining a lower substrate 401 which is a soft magnetic plate or a glass fiber substrate or a plate of conductive material having a thickness of 1 μm˜500 μm with heat conductive coefficient greater than 0.5 w/mk (please refer to FIG. 5-1).
2. Forming a basic conductive electrode pattern 300 constructed by a plurality of conductive electrodes 402a, 402b, 402c . . . aligned in different arrays. The conductive electrodes 402a, 402b, 402c . . . can be made of Cu, Ag, Al, Sn, Ni, or other conductive materials, or their alloys stacked one another on the lower substrate 401. The thickness of basic conductive electrode pattern 700 is 0.1 μm˜1 mm (please refer to FIG. 5-2). 3. Forming a plurality of coil units 403a, 403b . . . aligned in matrix array, between each two adjacent coil units 403a, 403b . . . are the lead wires 403a1, 403a2, 403b1, 403b2 . . . of each coil unit 403a, 403b . . . , while the adjacent lead wires 403a2, 403b1 . . . of two adjacent coil units can be the same one. The material of coil can be a copper wire or another conductive material, wherein, the copper wire can be coated by an insulated layer such as lacquer (please refer to FIG. 5-3).
4. Making electrical connection between the lead wires 403a1, 403a2, 403b1, 403b2 . . . of coil units 403a, 403b, . . . and the corresponding conductive electrodes 402a, 402b . . . , such that each of the coil units 403a, 403b . . . is respectively placed between two separate conductive electrodes 402a, 402b . . . (please refer to FIG. 5-4). This process is performed by welding or heat pressing.
5. Putting a post 4A into each of coil unit 403a, 403b, . . . (please refer to FIG. 5-5), said post 4A is a bar of magnetic or non-magnetic material, such as iron or related alloys and oxides; said post 4A is used for adjusting electric properties of power inductor.
6. Coating the surface of each coil unit 403a/403b/ . . . with a magnetic material colloid 404, this magnetic material colloid 404 may be a ferrite or iron and its alloy powder mixed with resins (please refer to FIG. 5-6).
7. Covering an upper substrate 405 on the upper surface of the magnetic material 404 serving as a fixing layer (please refer to FIG. 5-7). The upper and the lower substrates 405, 401 may be formed of the same material. After that baking the workpiece at 200° C., so as to harden the magnetic material 404 and stick it to the upper substrate 405
8. Using a cutting process to cut the baked substrate into a plurality of granular elements 2000 (as shown in FIG. 5-8).
9. After the single granular element is obtained, forming end electrodes 406 on its side surfaces, then the product of power inductor becomes a surface mounting device (as shown in FIG. 4-9).

In step 8 of the embodiment 2, 200° C. baking temperature is only one exemplary value used in the embodiment 2, and should not be construed as an only one limited value of temperature to be carried out in the fabrication process.

The steps for manufacturing power inductor described in Embodiments 1 & 2 can be adjusted according to necessities of elements as follows:
1. Before the coil is formed, as shown in FIG. 6, a bottom layer of magnetic material colloid 80 which is able to adjust the electric properties of devices can be formed on the upper surface of the lower substrate 201(401), the material forming the bottom layer of colloid can be the same as that of said magnetic material colloid 204, that is, a ferrite or iron and its alloy powder. After the bottom layer of magnetic material colloid 80 is formed onto the upper surface of lower substrate 201(401), the coil 203(403a, 403b) then is formed onto said bottom layer, such that the electric properties can be adjusted by said bottom layer of magnetic material colloid.
2. The upper substrate can be used according to the demands of electronic devices.
3. The coil can be placed or not placed with the post 2A(4A).
4. The step orders for forming coil and conductive electrode pattern can be exchanged.
5. The coils and conductive electrodes can be connected by welding or heat pressing.
6. The magnetic material colloid can be a mixture of ferrite colloid or iron or its alloy powder mixed with resins.
7. The upper and lower substrates can be formed by a single material or a plurality of materials stacked together, and the surfaces of the upper and lower substrates can be flat or formed with a plurality of grooves.
8. The bottom layer material colloid and the upper layer material colloid having magnetic properties can be injected, pressed or filled onto the conductive electrodes and coils.

It is understood that power inductor and its fabrication method of the present invention is a high level technical creation and, by no means, simply utilizes conventional technology or knowledge known prior to the application for patent or can easily made by persons skilled in the arts. The power inductor according to the present invention has the merits of simple in construction, easy to fabricate, secure to operate. The present invention will surely improve the quality of the traditional power inductor and benefit the present electronic engineering. The invention has neither been published nor put to pubic, therefore it is entitled for patent.

It is apparent to a person skilled in the art that the basic idea of the invention can be implemented in many different ways. The invention and its embodiments are thus not restricted to the examples described above, but may vary with the scope of the claims.

What is claimed is:

1. A method for fabricating a power inductor comprising the steps of:
preparing a lower substrate from a material having a thickness of 1 μm˜500 μm with heat conductive coefficient greater than 0.5 w/mk;
forming a basic conductive electrode pattern having a plurality of separated conductive electrodes on said lower substrate;
forming a bottom layer material colloid of magnetic properties on said lower substrate;
placing a coil on the surface of said bottom layer material colloid, wherein said coil is placed between two separated electrodes, and the two ends of coil are connected to said two separated electrodes respectively, then said two separated electrodes are electrically connected;
forming an upper layer material colloid of magnetic properties onto said coil and envelope it completely, so as to form the main body of power inductor having two electrodes exposed at two sides of the main body; and
finally, forming said electrodes on both sides of said power inductor main body to obtain a product of surface mounting device.

2. The method for fabricating a power inductor as claimed in claim 1, wherein said coil is filled with a post for adjusting electric properties of power inductor.

3. The method for fabricating a power inductor as claimed in claim 1, wherein the lower substrate can be formed by stacking a plurality of plates of same material or different materials.

4. The method for fabricating a power inductor as claimed in claim 1, wherein the surface of lower substrate is flat or formed with a plurality of grooves.

5. The method for fabricating a power inductor as claimed in claim 1, wherein the upper surface of said upper layer material colloid is covered with an upper substrate.

6. The method for fabricating a power inductor as claimed in claim 2, wherein said coil is selected from copper wires or other conductive wire materials coated with insulating layer, the lead ends of said coil are connected to said basic conductive electrode pattern by welding or heat pressing.

7. The method for fabricating a power inductor as claimed in claim 2, wherein said magnetic bottom layer material colloid and upper layer material colloid are formed of ferrite material or iron or its alloy powder to be mixed with resin(s).

8. The method for fabricating a power inductor as claimed in claim 2, wherein said magnetic bottom layer material colloid and upper layer material colloid are injected, pressed or filled onto the conductive electrodes and coils.

9. The method for fabricating a power inductor as claimed in claim 2, wherein said end electrodes are formed of Ag/Ni/Sn, Cu/Ni/Sn or Cu/Sn.

10. The method for fabricating a power inductor as claimed in claim 2, wherein said post is made of a soft magnetic material.

11. The method for fabricating a power inductor as claimed in claim 1, wherein the steps for forming basic conductive electrode pattern and bottom layer material colloid are exchanged.

12. The method for fabricating a power inductor as claimed in claim 1, wherein said bottom layer material colloid of magnetic properties has a plurality of units, on each unit a coil is placed between two separated electrodes, so as to form a substrate of multi inductor units, and then the substrate is cut into a plurality of granular elements, each of which has an inductor with electrodes exposed at two sides.

13. A power inductor comprising: a lower substrate; a pair of separated conductive electrodes formed on the upper surface of said lower substrate selected from a material having a thickness of 1 ˜m˜500 μm with heat conductive coefficient greater than 0.5 w/mk; a coil provided between said two separated conducting electrodes, wherein said coil and said separated electrodes are connected and fixed with said conductive electrodes; and a magnetic material colloid covering said conductive electrodes and said coil.

14. The power inductor as claimed in claim 13, wherein said lower substrate is formed by stacking a plurality of plates with a single material or a plurality of materials.

15. The power inductor as claimed in claim 13, wherein said magnetic material colloid is a mixture of resin with powder of ferrite material or iron or one of their alloys.

16. The power inductor as claimed in claim 13, wherein said power inductor further comprises an upper substrate stuck to said colloid.

17. The power inductor as claimed in claim 13, wherein said coil is provided with a post inside of it for adjusting the electrical properties of said power inductor by changing the position of said post inside said coil.

18. The power inductor as claimed in claim 16, wherein said lower substrate and said upper substrate are entrainers made of a soft magnetic material or a non-magnetic material.
